(19) United States
(12) Patent Application Publication
(10) Pub. No.: US 2010/0248503 A1
(43) Pub. Date: Sep. 30, 2010

(54) CONNECTOR CAPABLE OF COUPLING TO PRINTED CIRCUIT BOARD

(76) Inventors: Kyoung il Kang, Gyeonggi-do (KR); Yong Goo Lee, Seoul (KR); Duk Kyu Kwon, Gyeonggi-do (KR); Jang Mook Lee, Chungcheongnam-do (KR)

Correspondence Address: HARNESS, DICKEY, & PIERCE, P.L.C, 7700 Bonhomme, Suite 400, ST. LOUIS, MO, 63105, US

(21) Appl. No.: 12/741,300

(22) PCT Filed: Oct. 30, 2008
(86) PCT No.: PCT/KR2008/006400

§ 371 Date: May 4, 2010

(30) Foreign Application Priority Data
Nov. 6, 2007 (KR) 10-2007-0112678
Oct. 27, 2008 (KR) 10-2008-0105517

(51) Int. Cl. H01R 12/14

(52) U.S. Cl. 439/63

(57) ABSTRACT

A connector capable of being connected to a printed circuit board (PCB) is provided. A female connector according to an embodiment of the present invention includes a core conductor, a body, and a housing. The core conductor is formed of a single body including a contact terminal formed of two or more insertion panels forming an insertion space where a signal pin of a male connector is inserted and a signal transmission panel connected to a bottom of the contact terminal and electrically connected a signal line of the PCB. The body includes an insertion part electrically insulated from the core conductor and gaping when coupling with the male connector and is formed in a single body including a trunk surrounding the contact terminal and a plurality of supporters connected to a bottom of the trunk. The housing stores the core conductor and the bottom of the trunk of the body or more.

### TECHNICAL FIELD

The present invention relates to a connector connected to a plug, and more particularly, to a female connector and a male connector capable of being directly connected to a printed circuit board.

### BACKGROUND ART

Various signals are transmitted between wired or wireless communication devices. Wired or wireless communication devices where signals are transmitted are electrically connected to one another. Generally, as a connection method, there is a method of using a male connector and a female connector, which are manufactured to be capable of connected to be a coaxial cable.

For example, to effectively transmitting and receiving a wireless signal, there may be an antenna attached to a wireless communication device. In this case, generally, a male connector is installed in the antenna and a female connector is installed in the wireless communication device. However, a case reverse thereto is possible. In this case, a coaxial cable for transmitting/receiving a signal to/from an antenna circuit is connected to the male connector and a coaxial cable for transmitting/receiving a signal to/from an inner circuit in the wireless communication device is connected to the female connector.

As described above, in the case of conventional method where wired or wireless communication devices are connected to one another using a male connector and a female connector, to connect a male connector to an inner circuit of communication devices or to connect a female connector to an inner circuit of communication devices, there are used separate coaxial cables. That is, in this case, since a male connector or a female connector is indirectly connected to an inner circuit and connected thereto via a coaxial cable, it is incompatible to a tendency to decrease the size of wireless communication devices.

On the other hand, generally, an inner circuit of wireless communication devices is embodied as a printed circuit board (PCB). Technology on PCBs has been notably developed. Currently, there are widely used not only conventional hard PCBs but also flexible PCB (FPCB) capable of freely moving.

Accordingly, there is required a new male and female connector structure capable of simplifying a circuit configuration of wireless communication devices by directly connecting a male connector or a female connector to an FPCB.

### DETAILED DESCRIPTION OF THE INVENTION

### Technical Problem

The present invention provides a connector capable of being directly connected to a printed circuit board (PCB).

### Technical Solution

According to an aspect of the present invention, there is provided a female connector including: a core conductor, a body, and a dielectric.

The core conductor is formed in a single body including a contact terminal formed of two insertion panels forming an insertion space where a signal pin of a corresponding male connector is inserted and a signal transmission panel connected to a bottom of the contact terminal and electrically connected to a signal line of a printed circuit board (PCB).

The body includes an incision part electrically insulated from the core conductor and gaping when coupling with the male connector and is formed of a to trunk surrounding the contact terminal and a plurality of supporters connected to a bottom of the trunk. The dielectric couples the core conductor with the bottom of the trunk of the body.

On the trunk, a fastening groove is formed along an inner circumferential surface thereof to be coupled with the male connector and to prevent a separation of the male connector.

According to another aspect of the present invention, there is provided a female connector including a core conductor, a body, and a dielectric.

The core conductor is formed in a single body including a contact terminal formed of two insertion panels forming an insertion space where a signal pin of a corresponding male connector is inserted and a signal transmission panel connected to a bottom of the contact terminal and electrically connected to a signal line of a PCB.

The body includes an incision part electrically insulated from the core conductor and gaping when coupling with the male connector and is formed of a single body including a trunk surrounding the contact terminal and a plurality of supporters connected to a bottom of the trunk. The dielectric couples the core conductor with the bottom of the trunk of the body.

On the trunk, one or more fastening grooves are formed along an inner circumferential surface thereof to be coupled with the male connector and to prevent a separation of the male connector.

According to still another aspect of the present invention, there is provided a male connector including a signal pin, a body, and a dielectric.

The signal pin is formed in a single body including a pin part inserted into a corresponding female connector and a connection panel connected to a bottom of the pin part to be vertical thereto and extended long to be electrically connected to a signal line of a PCB;

The body includes an incision part electrically insulated from the signal pin and allowing the corresponding female connector to be easily attached and detached and is formed of a single body including a trunk surrounding the signal pin and a plurality of supporters connected to a bottom of the trunk. The dielectric couples the connection panel with the bottom of the trunk of the body.

One or more projections projected outwardly are formed along an outer circumferential surface of the trunk to be coupled with the corresponding female connector and to prevent a separation of the corresponding female connector.

According to yet another aspect of the present invention, there is provided a male connector including a signal pin, a body, and a dielectric.

The signal pin is formed in a single body including a pin part inserted into a corresponding female connector and a connection panel connected to a bottom of the pin part to be vertical thereto and extended long to be electrically connected to a signal line of a PCB.

The body includes an incision part electrically insulated from the signal pin and allowing the corresponding female connector to be easily attached and detached and is formed of a single body including a trunk surrounding the signal pin and a plurality of supporters connected to a bottom of the trunk. The dielectric couples the connection panel with the bottom of the trunk of the body.

A projecting part projected outwardly is formed along an outer circumferential surface of the trunk to be coupled with the corresponding female connector and to prevent a separation of the corresponding female connector.

According to a further aspect of the present invention, there is provided a male connector including a signal pin, a body, and a dielectric.

The signal pin is formed in a single body including a pin part inserted into a corresponding female connector and a connection panel connected to a bottom of the pin part to be vertical thereto and extended long to be electrically connected to a signal line of a PCB.

The body includes an incision part electrically insulated from the signal pin and allowing the corresponding female connector to be easily attached and detached and is formed of a single body including a trunk surrounding the signal pin and a plurality of supporters connected to a bottom of the trunk. The dielectric couples the connection panel with the bottom of the trunk of the body.

The trunk is coupled with the female connector while surrounding the outside thereof, and one or more projections are formed along an inner circumferential surface of the trunk to be coupled with the corresponding female connector and to prevent a separation of the corresponding female connector.

According to another aspect of the present invention, there is provided a male connector including a signal pin, a body, and a dielectric.

The signal pin is formed in a single body including a pin part inserted into a corresponding female connector and a connection panel connected to a bottom of the pin part to be vertical thereto and extended long to be electrically connected to a signal line of a PCB.

The body includes an incision part electrically insulated from the signal pin and allowing the corresponding female connector to be easily attached and detached and is formed of a single body including a trunk surrounding the signal pin and a plurality of supporters connected to a bottom of the trunk. The dielectric couples the connection panel with the bottom of the trunk of the body.

The trunk is coupled with the female connector while surrounding the outside thereof and a projecting part formed in the shape of a groove is formed along an inner circumferential surface of the trunk to be coupled with the corresponding female connector and to prevent a separation of the corresponding female connector.

According to another aspect of the present invention, there is provided a connector structure formed by coupling a male connector with a female connector. The female connector includes a core conductor formed in a single body including a contact terminal formed of two insertion panels forming an insertion space where a signal pin of a corresponding male connector is inserted and a signal transmission panel connected to a bottom of the contact terminal and electrically connected to a signal line of a PCB; a body including an incision part electrically insulated from the core conductor and gaping when coupling with the male connector, the body formed of a single body including a trunk surrounding the contact terminal and a plurality of supporters connected to a bottom of the trunk; and a dielectric coupling the core conductor with the bottom of the trunk of the body, wherein, on the trunk, one or more fastening grooves are formed along an inner circumferential surface thereof to prevent a separation of the male connector.

The male connector includes: a signal pin formed in a single body including a pin part inserted into a corresponding female connector and a connection panel connected to a bottom of the pin part to be vertical thereto and extended long to be electrically connected to a signal line of a PCB; a body including an incision part electrically insulated from the signal pin and allowing the corresponding female connector to be easily attached and detached, the body formed of a single body including a trunk surrounding the signal pin and a plurality of supporters connected to a bottom of the trunk; and a dielectric coupling the connection panel with the bottom of the trunk of the body, wherein one or more projections projected outwardly are formed along an outer circumferential surface of the trunk to prevent a separation of the corresponding female connector, and the projection of the male connector is coupled with the fastening groove of the female connector.

According to another aspect of the present invention, there is provided a connector structure formed by coupling a male connector with a female connector. The female connector includes: a core conductor formed in a single body including a contact terminal formed of two insertion panels forming an insertion space where a signal pin of a corresponding male connector is inserted and a signal transmission panel connected to a bottom of the contact terminal and electrically connected to a signal line of a PCB; a body including an incision part electrically insulated from the core conductor and gaping when coupling with the male connector, the body formed of a single body including a trunk surrounding the contact terminal and a plurality of supporters connected to a bottom of the trunk; and a dielectric coupling the core conductor with the bottom of the trunk of the body, wherein, on the trunk, a fastening groove is formed along an inner circumferential surface thereof to be coupled with the male connector and to prevent a separation of the male connector.

The male connector includes: a signal pin formed in a single body including a pin part inserted into a corresponding female connector and a connection panel connected to a bottom of the pin part to be vertical thereto and extended long to be electrically connected to a signal line of a PCB; a body including an incision part electrically insulated from the signal pin and allowing the corresponding female connector to be easily attached and detached, the body formed of a single body including a trunk surrounding the signal pin and a plurality of supporters connected to a bottom of the trunk; and a dielectric coupling the connection panel with the bottom of the trunk of the body, wherein a projecting part projected outwardly is formed along an outer circumferential surface of the trunk to be coupled with the corresponding female connector and to prevent a separation of the corresponding female connector, and the projecting part of the male connector is coupled with the fastening groove of the female connector.

### ADVANTAGEOUS EFFECTS

As described above, a female connector and a male connector according to an embodiment of the present invention have advantages of simplifying a circuit configuration of a wireless communication device and reducing a size thereof by directly connecting to a printed circuit board (PCB) and strongly coupling with each other by fastening grooves, projections, and projecting parts.

### BRIEF DESCRIPTION OF THE DRAWINGS

FIG. 1 is a view illustrating a female connector connected to a printed circuit board (PCB);

FIG. 2 is a view illustrating a male connector connected to a PCB;

FIG. 3 is a view illustrating a core conductor of a female connector connected to a PCB;

FIG. 4 is a view illustrating the opposite side of the core conductor of FIG. 3;

FIG. 5 is a perspective view illustrating the core conductor of FIGS. 3 and 4;

FIG. 6 is a perspective view illustrating a body of the female connector of FIGS. 3 and 4;

FIG. 7 is a perspective view illustrating the core conductor of FIG. 5 coupled with the body of FIG. 6;

FIG. 8 is a perspective view illustrating a structure of a body including a fastening projection;

FIG. 9 is a perspective projection view of a female connector according to an embodiment of the present invention;

FIG. 10 is a perspective view illustrating a core conductor of the female connector of FIG. 9;

FIG. 11 is a perspective view illustrating a body of the female connector of FIG. 9;

FIG. 12 is a perspective view illustrating the core conductor coupled with the body;

FIG. 13 is a perspective view illustrating another structure of the female connector of FIG. 9;

FIG. 14 is a perspective projection view illustrating a male connector according to an embodiment of the present invention;

FIG. 15 is a perspective view illustrating a signal pin of the male connector of FIG. 14;

FIG. 16 is a perspective cross-sectional view illustrating the signal pin of FIG. 15;

FIG. 17 is a perspective view illustrating a body of the male connector;

FIG. 18 is a perspective view illustrating the signal pin coupled with the body;

FIG. 19 is a perspective view illustrating another structure of the male connector of FIG. 14;

FIG. 20 is a perspective view illustrating the male connector to be coupled with the female connector; and

FIG. 21 is a cross-sectional view illustrating the male connector coupled with the female connector.

### BEST MODE FOR CARRYING OUT THE INVENTION

To fully understand advantages of operations of the present invention and the objects obtained by embodiments of the present invention, it is required to refer to attached drawings illustrating preferable embodiments of the present invention and contents shown in the drawings.

Hereinafter, the preferable embodiments of the present invention will be described in detail with reference to the attached drawings. The same reference numerals shown in each drawing indicate the same elements.

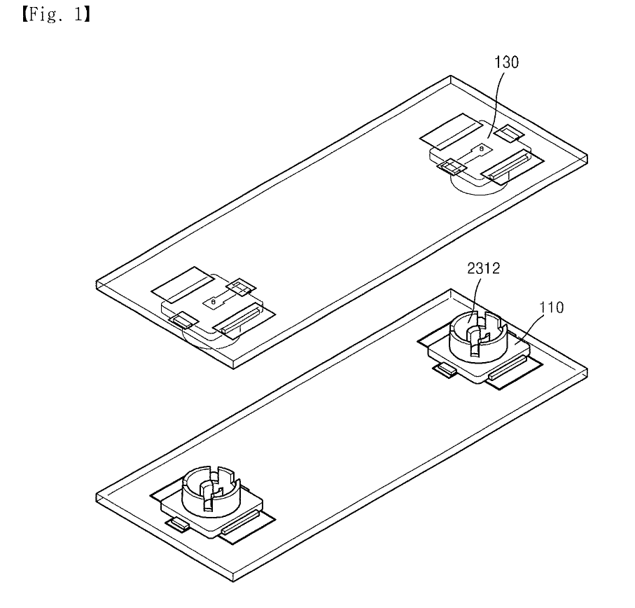

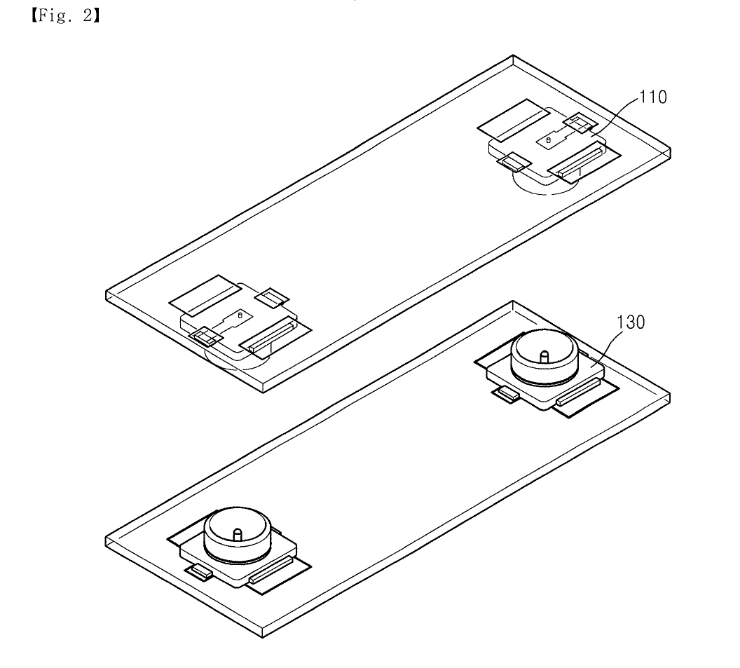

FIGS. 1 and 2 illustrate examples of using a female connector. FIG. 1 illustrates a female connector 110 connected to a printed circuit board (PCB), and FIG. 2 illustrates a male connector 130 connected to a PCB. As shown in FIGS. 1 and 2, the female 110 and/or the male connector 130 are connected to the PCB and coupled with each other to transmit a signal.

A fastening projection 2312 of the female connector, shown in FIG. 1, will be described later.

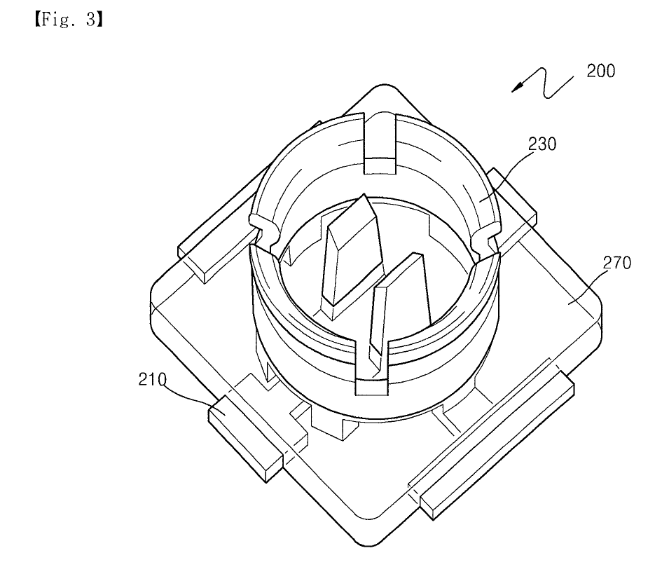

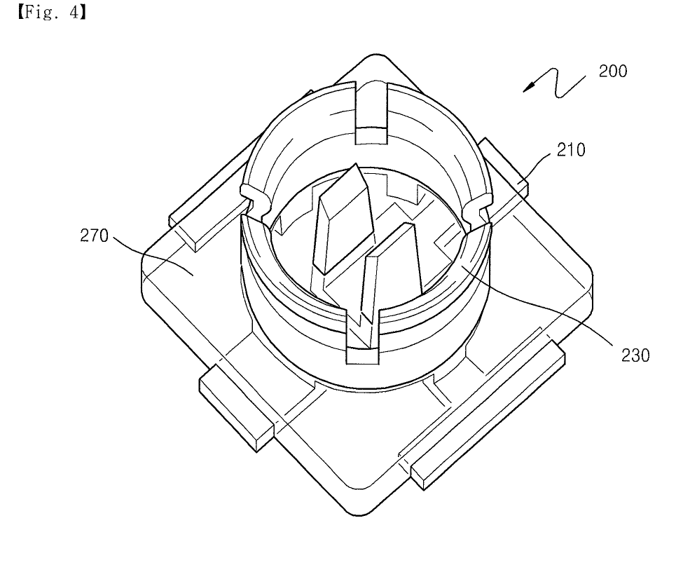

FIGS. 3 and 4 are perspective projection views illustrating a female connector 200. FIG. 3 illustrates a core conductor 210 connected to a PCB (not shown), and FIG. 4 illustrates an opposite view of the core conductor 210. Referring to FIGS. 3 and 4, the female connector 200 includes the core conductor 210, a body 230, and a housing 270. Hereinafter, a structure of the female connector 200 will be described in detail with reference to FIGS. 3 and 7.

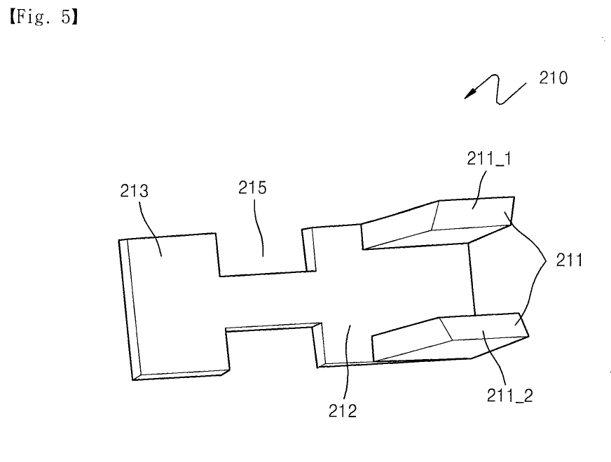

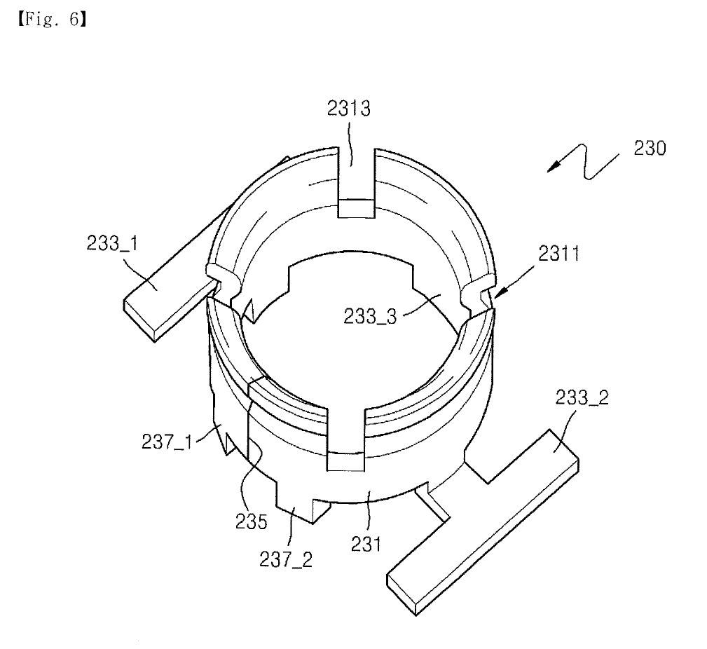

FIG. 5 is a perspective view illustrating the core conductor 210. FIG. 6 is a perspective view illustrating the body 230. FIG. 7 is a perspective view illustrating the core conductor 210 coupled with the body 230. Referring to FIG. 5, the core conductor 210 is formed of a single body including a contact terminal 211 and a signal transmission panel 213.

The contact terminal 211 includes two or more insertion panels 211_1 and 211_2. The two or more insertion panels 211_1 and 211_2 form an insertion space 212 where a signal pin of a male connector (refer to FIGS. 1 and 2) is inserted. Therefore, signal pin is electrically connected to the core conductor 210, thereby transmitting a signal.

Also, to efficiently perform an electrical connection between the signal pin and the core conductor 210, the insertion panels 211_1 and 211_2 may be formed slant to a direction of the insertion space.

Referring to FIG. 5, the signal transmission panel 213 is connected to a bottom of the contact terminal 211 as a single body. As shown in FIGS. 1 and 2, the female connectors 110 and 200 are directly connected to a PCB. The signal transmission panel 213 is electrically connected to a signal line of the PCB, thereby forming a signal transmission line by using a signal pin and a core conductor of the male connector and the signal line of the PCB.

On the other hand, as shown in FIGS. 1 and 2, the female connectors 110 and 200 are directly connected to the PCB. However, the signal transmission panel 213 may be connected to the PCB using surface mount technology.

On the other hand, as shown in FIG. 5, a groove 215 is formed in the middle of the signal transmission panel 213. Accordingly, a width of the middle of the signal transmission panel 213 is narrower than that of other parts of the signal transmission panel 213. Such groove is a part for coupling with incision preventing panels 237_1 and 237-2 formed on the body 230, which will be described later.

Referring to FIG. 6, the body 230 includes a trunk 231 and a plurality of supporters 233_1 to 233_3. As shown in FIG. 6, the trunk 231 in the shape of a hollow cylinder surrounds the contact terminal 211. Also, the trunk 231 includes an incision part 235 to easily coupling one of the female connectors 110 and 200 with the male connector 130. That is, when coupling with the male connector 130, the incision part 235 gapes, thereby easily coupling the male connector 130 with one of the female connectors 110 and 200.

On the other hand, since the incision part 235 is a part formed by incising a surface of the trunk 231, the incision part 235 may gape or there may occur a deformation in the trunk 231 due to cumulatively attaching or detaching. To prevent such phenomenon, in the present embodiment, a pair of the gap-preventing panels 237_1 and 237_2 is formed on a bottom of the trunk 231.

As shown in FIG. 6, in the present embodiment, the incision part 235 is located between the pair of the gap-preventing panels 237_1 and 237_2, thereby preventing the incision part 235 from gaping and preventing a deformation of the trunk 231. That is, the pair of the gap-preventing panels 237_1 and 237_2 to interposing the incision part 235 therebetween are fastened to the housing 270, which will be described later, thereby preventing a phenomenon in which the incision part 235 gapes when coupling with the male connector 130 and preventing the deformation of the trunk 231.

On the other hand, to efficiently use an inner space of a female connector, in the present embodiment, the signal transmission panel 213 may pass through the pair of the gap-preventing panels 237_1 and 237_2 while connected to the signal line of the PCB (refer to FIG. 7). For this, the groove 215 is formed on the signal transmission panel 213 located corresponding to the pair of the gap-preventing panels 237_1 and 237_2. Accordingly, the width of the signal transmission panel 213, corresponding to an interval between the gap-preventing panels 237_1 and 237_2 is narrower than that of others of the signal transmission panels 213.

On the other hand, the plurality of supporters 233_1 to 233_3 is connected to the bottom of the trunk as a single body. The body 230 may be strongly supported by the plurality of supporters 233_1 to 233_3.

Referring to FIG. 6, a fastening groove 2311 formed by winding a surface of the trunk 231 may be further formed on the trunk 231. In the present embodiment, the fastening groove 2311 prevents the male connector from voluntarily departing after coupling and is formed along a circumference of a top of the trunk 231. Since the fastening groove 231 is formed along the circumference of the trunk 231 and projected toward an inner space, that is, an outer surface is sunk toward the inner space and an inner surface is projected toward the inner space, a groove (not shown) formed on a trunk of the male connector is fastened to a threshold of the inner surface, formed by the fastening groove 2311, thereby preventing a separation of the male connector.

On the other hand, in the present embodiment, one or more coupling assisting grooves 2313 may be formed on the fastening groove 2311. It may be more easily performed to attach or detach the male connector by using the coupling assisting grooves 2313. That is, when coupling the trunk of the male connector with the trunk of the female connector, the top of the trunk of the female connector gapes a little due to the coupling assisting groove 2313, thereby easily attaching and detaching the male connector.

As another embodiment for preventing the separation of the male connector, one or more fastening projections 2312 (refer to FIGS. 1 and 2) may be used. As shown in FIGS. 1 and 2, the fastening projection 2312 may be formed on an inner circumferential surface of the trunk. That is, the fastening projection 2312 is fastened to the groove formed on the trunk of the male connector, thereby preventing the separation of the male connector.

Generally, in FIG. 5, though there is not used an additional material to electrically insulate the core conductor 210 form the body 230, to prevent electromagnetic interference that may occur between the core conductor 210 and the body 230, various materials capable of electrically insulating may be used as an additional insulating element (not shown) in the present embodiment. In this case, the insulating element is interposed between the core conductor 210 and the body 230 and electrically insulates the core conductor 210 from the body 230.

On the other hand, as shown in FIG. 5, in the housing 270, the core conductor 210 and the bottom of the trunk or more of the body 230 are stored.

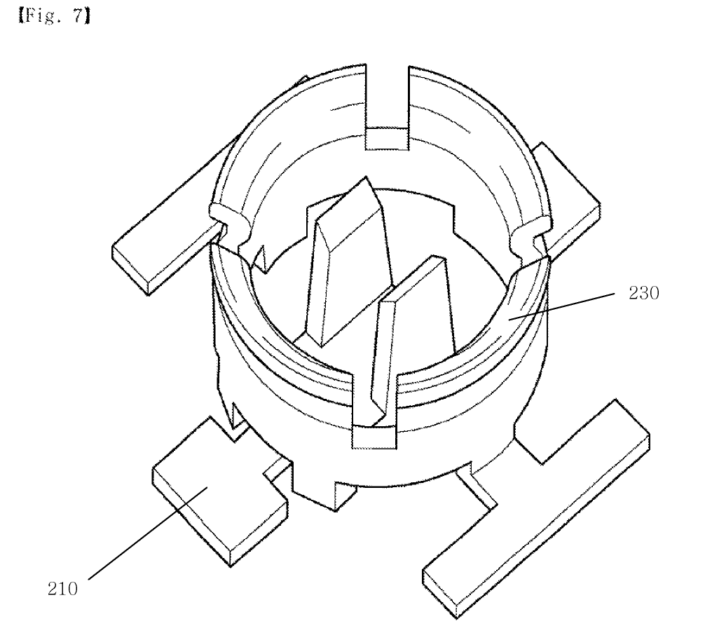

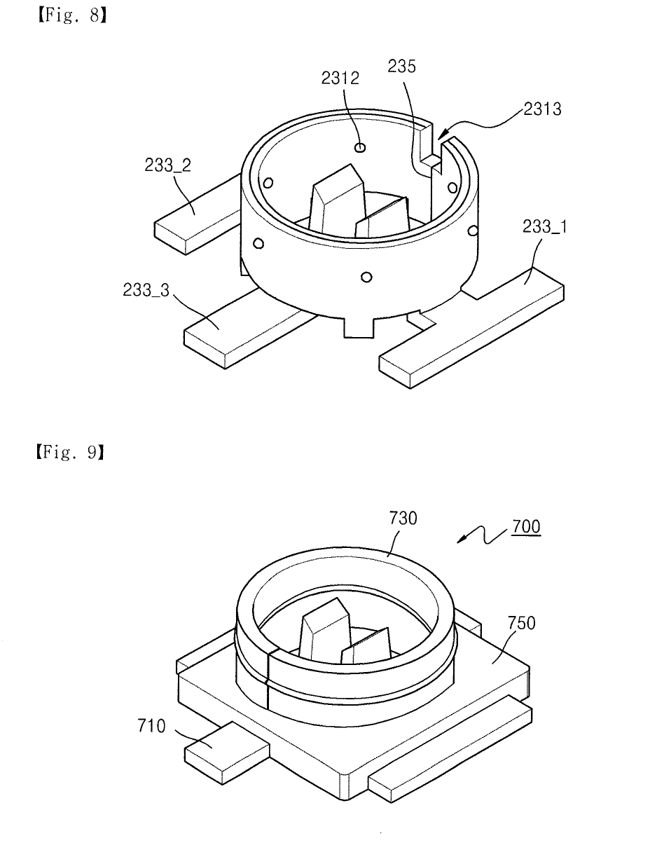

FIG. 8 is a perspective view illustrating a structure of a body including a fastening projection.

As another embodiment for preventing the separation of the male connector, a plurality of the fastening projections 2312 shown in FIGS. 1 and 2 may be formed on an inner circumferential surface of the trunk 231. Except for the structure including the fastening projection 2312 instead of the fastening groove 2311, the structure of a body including the supporters 233_1 to 233_3, the incision part 235, and the coupling assisting groove 2313 is identical to that of the body 230.

The fastening projection 2312 is formed projected from the inner circumferential surface of the trunk toward the inner space. An outer circumferential surface of the trunk, corresponding to the fastening projection 2312, includes a groove formed inside. The fastening projection 2312 is coupled with and fastened to the groove formed on the trunk of the male connector, thereby preventing the separation of the male connector.

As described above, there has been described a configuration where the female connector 200 is directly connected to the PCB. However, those skilled in the art may know that the present invention may be applied to various PCBs, and particularly, to a flexible PCB.

FIG. 9 is a perspective projection view illustrating a female connector 700 according to another embodiment of the present invention.

Referring to FIG. 9, the female connector 700 includes a core conductor 710, a body 730, and a dielectric coupling the core conductor 710 with a bottom of a trunk of the body 730. Hereinafter, a structure of the female connector 700 will be described in detail with reference to FIGS. 9 to 12.

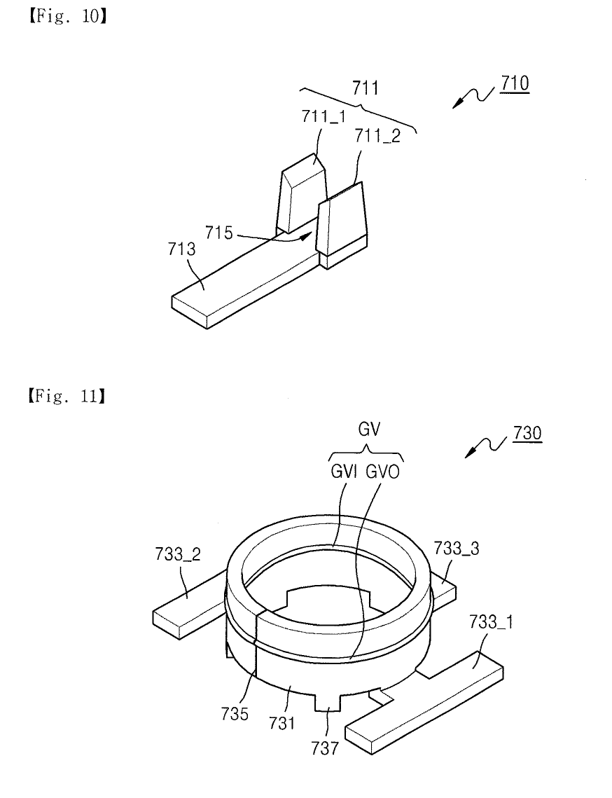

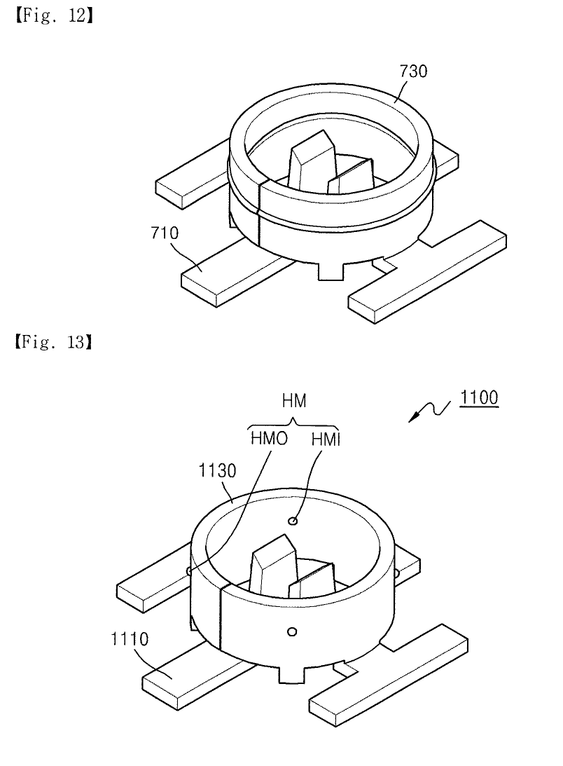

FIG. 10 is a perspective view illustrating the core conductor 710. FIG. 11 is a perspective view illustrating the body 730. FIG. 12 is a perspective view illustrating the core conductor 710 coupled with the body 730.

Referring to FIG. 10, the core conductor 710 is formed of a single body including a contact terminal 711 and a signal transmission panel 713. The contact terminal 711 includes two or more insertion panels 711_1 and 711_2. An insertion space 715 is formed by the two or more insertion panels 711_1 and 711_2. A signal pin (not shown) of a male connector is inserted into the insertion space 715.

The signal pin of the male connector is inserted into the insertion space 715, thereby electrically connecting the signal pin to the core conductor 710 to transmit a signal.

Also, to surely perform electrical connection between the signal pin of the male connector and the core conductor 710, as the structure of the core conductor 210 shown in FIG. 5, the insertion panels 711_1 and 711_2 are formed slant toward the insertion space 715.

The signal transmission panel 713 is connected to a bottom of the contact terminal 711 as a single body. As the female connector 100 or 200 shown in FIG. 1, the female connector 700 is also directly connected to a PCB. The signal transmission panel 713 is electrically connected to a signal line of the PCB. Accordingly, the signal pin of the male connector, the core conductor 710, and the signal line of the PCB may form one signal transmission line.

The female connector 700 is directly connected to the PCB. Particularly, the signal transmission panel 713 may be connected to the PCB using surface mount technology. In this case, the PCB may be a flexible PCB.

Though the signal transmission pane 713 shown in FIG. 10 is in the shape of a straight stick but not limited thereto. The groove 215 may be formed in the middle of the signal transmission panel 713, as the signal transmission panel 213 to shown in FIG. 5.

Referring to FIG. 11, the body 730 includes a trunk 731 and a plurality of supporters 733_1 to 733_3. As shown in FIG. 11, the trunk 731 is in the shape of a hollow cylinder and surrounds the contact terminal 711. Also, the trunk 731 includes an incision part 735 to easily couple the female connector 711 with a male connector (not shown). That is, the incision part 735 gapes when coupling with the male connector, thereby easily coupling the male connector with the female connector 700.

As the body 230 of FIG. 6, to prevent a gap in the incision part 735 or a deformation of the trunk 731, caused by repeatedly attaching and detaching the male connector, a pair of gap-preventing panels 737 is formed on a bottom of the trunk 731.

As shown in FIG. 11, the incision part 735 is located between the pair of gap-preventing panels 737, thereby preventing the gap of the incision part 735 and the deformation in the trunk 731.

That is, the pair of gap-preventing panels 737 is fastened to the dielectric 750, thereby preventing a phenomenon in which the incision part 735 gapes while coupling with the male connector and also preventing the deformation of the trunk 731. The core conductor 710, a bottom of the trunk 731 of the body 730, and the dielectric 750 are coupled with one another using an insert molding method. In this case, the dielectric 750 performs like the housing 270 of the female connector of FIG. 3.

The plurality of supporters 733_1 to 733_3 is connected to the bottom of the trunk 731 as a single body. The body 730 may be strongly supported by the to plurality of supporters 733_1 to 733_3.

Referring to FIG. 11, a fastening groove GV for preventing the male connector after coupling therewith is formed along an inner circumferential surface of the trunk 731.

The fastening groove GV prevents the male connector from voluntary separation after coupling therewith. The fastening groove GV is formed along a circumference of a top of the trunk 231 and projected opposite to the fastening groove 2311 formed on the body 230 of FIG. 6.

That is, the fastening groove 2311 of FIG. 6 is formed along a circumference of a trunk and projected toward an inner space in such a way that an outer surface is sunk toward the inner space and an inner surface is projected toward the inner space. However, in the case of the fastening groove GV of FIG. 11, a groove GVI is formed on the inner circumferential surface of the trunk 731 and a projecting part GVO is formed on a corresponding outer circumferential surface and projected outwardly.

Since the male connector is inserted into the inner space of the body 730 and coupled with the female connector 700, a projection is formed on an outside of the body of the male connector and coupled with and fastened to the groove GVI of the fastening groove formed on the inner circumferential surface of the body 730 of the female connector 700, thereby preventing a separation of the male connector. A structure of such male connector will be described later.

Though not shown in FIG. 11, similar to the structure of the body 230 of FIG. 6, one or more coupling assisting grooves 2313 may be formed on the body 730 shown in FIG. 11. Since the structure and functions of the coupling assisting groove 2313 has been already described, a further detailed description will be omitted.

As another embodiment for preventing the separation of the male connector, a method of using one or more fastening grooves HM will be described with reference to FIG. 13.

FIG. 13 is a perspective view illustrating another structure of the female connector 700 of FIG. 9.

Though there is not shown a dielectric, it is just for convenience for description and a body 1130 is coupled with a core conductor 1110 by the dielectric (not shown) like the structure of the female connector 700 of FIG. 9.

In the case of a female connector 1100 shown in FIG. 13, one or more fastening grooves HM are formed along an inner circumferential surface of a trunk of the body 1130 and prevent a separation of a male connector after coupling therewith. That is, the one or more fastening grooves HM are formed instead of the fastening grooves. A fastening groove HMI formed on the inner circumferential surface of the trunk is sunk toward the outside of the trunk to form a groove, and a part HMO on an outer circumferential surface, corresponding to the fastening groove HMI is projected outwardly. Accordingly, the fastening groove has an embossment shape.

The fastening groove HM is formed in a direction opposite to the fastening projection 2312 formed on the body of FIG. 8 and a projection (not shown) to be coupled with the fastening groove HM is formed on a trunk of a corresponding male connector. The fastening groove HM is coupled with the projection, thereby preventing the separation of the male connector.

Since the female connector 1100 of FIG. 13 is similar to the female connector 700 except for the fastening groove HM formed instead of the fastening groove GV, a description for others of the structure thereof will be omitted. Since including the fastening groove GV and the fastening groove HM having the structure projected from the inner space toward the outside, the female connectors 700 and 1100 of FIGS. 9 and 13 may be strongly coupled with the male connector more than the female connector 200 having the fastening groove projected toward the inner space.

Also, due to the structures including the fastening groove GV or the fastening groove HM projected from the inner space toward the outside, when insert molding a dielectric in a manufacturing process, a core (not shown) preventing emitted resin may be easily inserted into the inner space of the female connectors 700 and 1100. That is, since the female connector 200 having the fastening groove projected toward the inner space has a projected part in the inner space, it is inconvenient to insert the core. However, in the case of the female connectors 700 and 1100, it is easy to insert the core into the inner space.

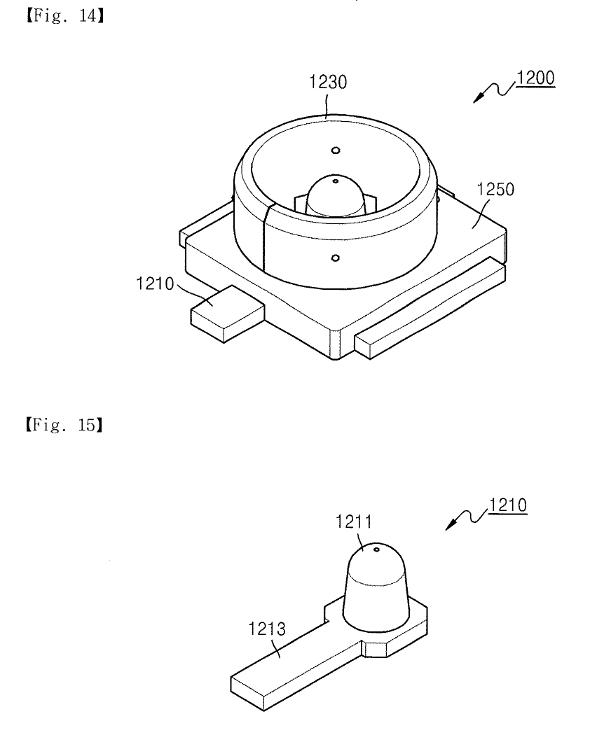

FIG. 14 is a perspective projection view illustrating a male connector 1200 according to an embodiment of the present invention.

Referring to FIG. 14, the male connector 1200 includes a signal pin 1210, a body 1230, and a dielectric 1250 coupling the signal pin 1210 with a bottom of a trunk of the body 1230. Hereinafter, a structure of the male connector 1200 will be described in detail with reference to FIGS. 14 to 18.

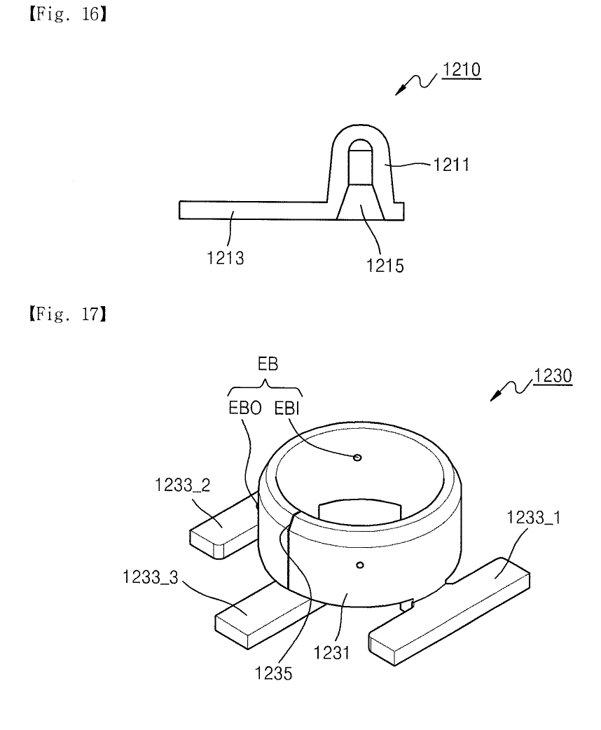

FIG. 15 is a perspective view illustrating the signal pin 1210. FIG. 16 is a cross-sectional view illustrating the signal pin 1210. FIG. 17 is a perspective view illustrating the body 1230. FIG. 18 is a perspective view illustrating the signal pin 1210 coupled with the body 1230.

Referring to FIG. 15, the signal pin 1210 is formed in a single body including a pin part 1211 and a connection panel 1213. The pin part 1211 is inserted into a corresponding female connector. In detail, the pin part 1211 is inserted into one of the insertion space 212 or 715 between the insertion panels 211_1 and 211_2 or 711_1 and 711_2 of the female connectors 200 and 700 shown in FIGS. 3, 4, and 9 in such a way that the core conductor of one of the female connectors 200 and 700 is electrically connected to the signal pin 1210 of the male connector 1200.

The connection panel 1213 is connected to a bottom of the pin part 1211 in a single body to be vertical to the pin part 1211 and extended long to be electrically connected to a signal line of a PCB.

That is, the male connector 1200 is also directly connected to a PCB, as the female connectors 100 and 200 shown in FIGS. 1 and 2. The connection panel 1213 is electrically connected to the signal line of the PCB. Accordingly, a core conductor of a female connector, the signal pin 1210 of the male connector 1200, and the signal line of the PCB may form one signal transmission line.

The connection panel 1213 may be connected to the PCB using surface mount technology. In this case, the PCB may be a flexible PCB.

The connection panel 1213 shown in FIG. 15 is in the shape of a straight stick but limited thereto. Also, the connection panel 1213 may include a groove 215 in the middle thereof, as the signal transmission panel 213 of the female connector 200 shown in FIG. 5.

Referring to FIG. 16, the pin part 1211 includes an inner space 1215 formed therein. That is, in a manufacturing process, one side of one end of the signal pin 1210 is struck and an opposite side thereof is projected, thereby forming the pin part 1211.

Referring to FIG. 17, the body 1230 includes a trunk 1231 and a plurality of supporters 1233_1 to 1233_3 connected to a bottom of the trunk 1231 as a single body.

As shown in FIG. 17, the trunk 1231 is in the shape of a hollow cylinder and surrounds the signal pin 1210. Also, the trunk 1231 includes an incision part 1235 to easily couple with the female connector 700. That is, due to the incision part 1235, it may be easy to be coupled with a female connector.

Though not shown in FIG. 17, as the body 730 of the female connector 700 of FIG. 9, to prevent a gap of the incision part 1235 and a deformation in the trunk 1231, there may be formed a pair of gap-preventing panels on the bottom of the trunk 1231. Also, the connection panel 1213 may pass through the gap-preventing panels and be connected to the signal line.

The signal pin, the bottom of the trunk 1231 of the body 1230, and the dielectric 1250 are coupled with one another using an insert molding method. In this case, the dielectric 1250 performs the same function of the housing 270 of the female connector 200 of FIG. 3.

The plurality of supporters 1233_1 to 1233_3 is connected to the bottom of the trunk 1231. The body 730 may be strongly supported by the plurality of supporters 1233_1 to 1233_3.

Referring to FIG. 17, on the trunk 1231, one or more projections EB are formed along an outer circumferential surface of the trunk 1231 to surely couple with a female connector (not shown). The projections EB prevents the male connector 1200 from a voluntary separation after coupled with the female connector.

A projection EBO formed on the outer circumferential surface of the trunk 1231 of FIG. 17 is formed along the outer circumferential surface and projected outwardly, and a groove is formed on a part EBI on an inner circumferential surface, corresponding to the projection EBO, the part EBI having an embossed shape.

The male connector 1200 having the body 1230 as shown in FIG. 17 is coupled with, for example, the female connector 1100 having the structure shown in FIG. 13. Then, since the projections EB of the male connector 1200 are coupled with the fastening groove HM of the female connector 1100, it is possible to prevent the male connector 1200 from easy separation from the female connector 110 after coupling therewith.

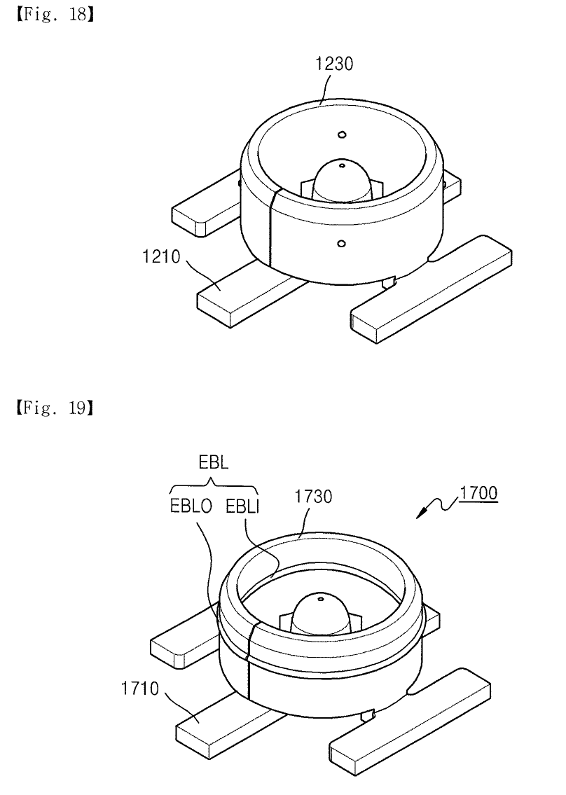

As another embodiment for preventing a separation of a male connector in a coupling state, a method of using a projecting part will be described with reference to FIG. 19.

FIG. 19 is a perspective view illustrating another structure of the male connector 1200 of FIG. 14.

Though there is not shown a dielectric in FIG. 19, it is just for convenience for description. A body 1730 is coupled with a signal pin 1720 by a dielectric, like the structure of the male connector 1200 of FIG. 14.

In the case of a male connector 1700 shown in FIG. 19, a projecting part EBL projected outwardly is formed along an outer circumferential surface of a trunk of the body 1730 and prevents a separation of the male connector 1700 after coupling with a female connector.

That is, instead of the projections EB, the projecting part EBL is formed along the outer circumferential surface. A projecting part EBLO formed on the outer circumferential surface of the trunk is projected toward the outside of the trunk, and a part EBLI on an inner circumferential surface, corresponding to the projecting part EBLO, has a groove sunk toward the outside of the trunk.

The male connector 1700 having such the projecting part EBL may be coupled with the female connector 700 having the fastening groove GV. Then, after the body 1730 of the male connector 1700 is inserted into the body 730 of the female connector 700, the projecting part EBL is coupled with and fastened to the fastening groove GV, thereby preventing the separation of the male connector 1700.

Except for the projecting part EBL formed instead of the projection EB, the male connector 1700 has a structure similar to the male connector 1200 of FIG. 14. Accordingly, others of the structure thereof will be omitted.

As another embodiment of the present invention, since including the bodies 1230 and 1730 having diameters greater than those of the bodies 730 and 1130 of the female connectors 700 and 1100, the male connectors 1200 and 1700 may surround the female connectors 700 and 1100 while coupling therewith.

Generally, a body of a male connector is inserted into a body of a female connector, thereby coupling the female connector with the male connector. However, when a diameter of the body of the male connector is greater than that of the body of the female connector, the body of the male connector may surround the body of the female connector.

That is, when designing the diameter of the body 1230 of the male connector 1200 to be greater than that of the body 1130 of the female connector 1100, the body 1230 of the male connector 1200 surrounds the body 1130 of the female connector 1100 while coupling with the female connector 1100.

Then, the fastening groove HMO formed on the outer circumferential surface of the body 1130 of the female connector 1100 is coupled with the projection EBI formed on the inner circumferential surface of the body 1230 of the male connector 1200, thereby preventing a separation of the female connector 1100.

Since such structure of the male connector 1200 is similar to the structure shown in FIG. 14 except for the diameter of the body 1230 greater than that of the body 1130 of the corresponding female connector 1100, a description for others of the structure will be omitted.

Also, when designing the diameter of the body 1730 of the male connector 1700 to be greater than that of the body 730 of the female connector 700, the body 1730 of the male connector 1700 surrounds the body 730 of the female connector 700 on the outside of the female connector 700 while coupling with the female connector 700.

Then, the fastening groove GVO formed on the outer circumferential surface of the body 730 of the female connector 700 is coupled with the projecting part EBLI formed on the inner circumferential surface of the body 1730 of the male connector 1700, thereby preventing a separation of the female connector 700.

Since such structure of the male connector 1700 is similar to the structure shown in FIG. 19 except for the diameter of the body 1730 greater than that of the body 730 of the corresponding female connector 700, a description for others of the structure will be omitted.

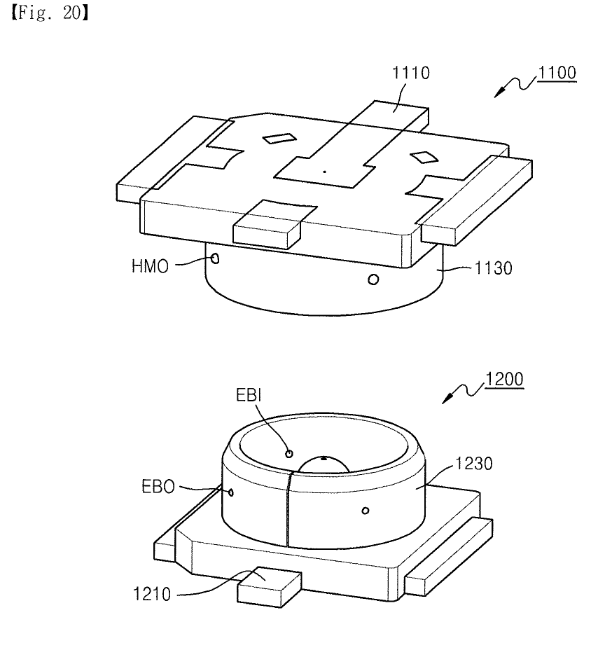

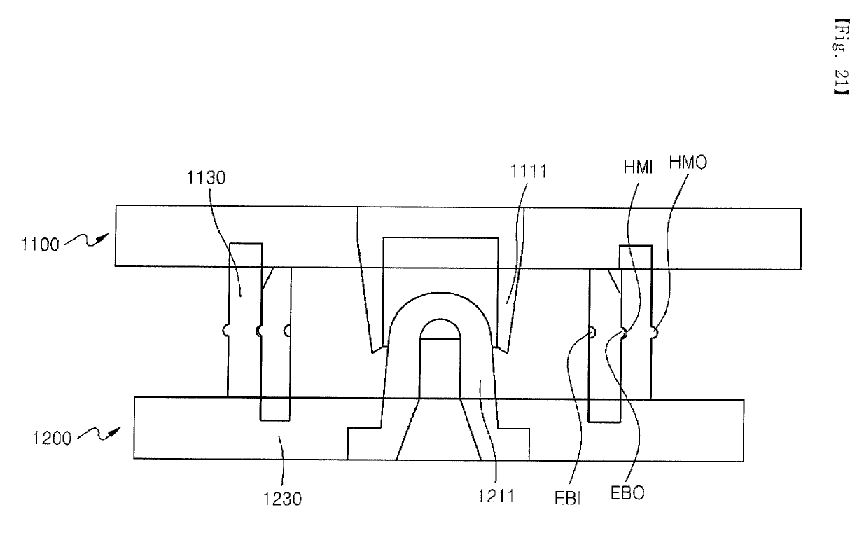

FIG. 20 is a perspective view illustrating a male connector to be coupled with a female connector. FIG. 21 is a cross-sectional view illustrating the male connector coupled with the female connector.

Referring to FIGS. 20 and 21, the female connector of FIG. 20 is identical to the female connector 1100 shown in FIG. 13 and the male connector shown in FIG. 20 is identical to the male connector 1200 shown in FIG. 14.

That is, in the case of the female connector 1100, the fastening groove HM is formed on the body 1130, the fastening groove HMO formed on the outer circumferential surface of the body 1130 is projected outwardly, and the fastening groove HMI formed on the inner circumferential surface has a structure where a groove is formed therein. Also, in the case of the male connector 1200, the projection EB is formed on the body 1230, the projection EBO formed on the outer circumferential surface of the body 1230 is projected outwardly, and the projection EBI formed on the inner circumferential surface of the body 1230 has a structure where a groove is formed therein.

The body 1230 of the male connector 1200 is inserted into the inside of the body 1230 of the female connector 1100 and the pin part 1211 of the signal pin 1210 is in contact with an insertion terminal 1111 of the core conductor 1110 of the female connector 1100 and electrically connected thereto. In this case, the projection EBO formed on the outer circumferential surface of the male connector 1200 is coupled with the fastening groove HMI formed on the inner circumferential surface of the female connector 1100, thereby strongly coupling the male connector 1200 with the female connector 1100.

Though there is shown the male connector 1200 coupled with the female connector 1100 in FIGS. 20 and 21, the male connector 1700 having the projecting part EBL of FIG. 19 may be coupled with the female connector 700 having the fastening groove GV of FIG. 9. A detailed description thereon will be omitted.

Also, though not shown in the drawing, the male connector 1200 shown in FIG. 14, including the body 1230 where the projection EB is formed, may be coupled with the female connector 700 having the fastening groove GV shown in FIG. 9. The projection EBO projected outwardly, formed on the outer circumferential surface, is coupled with the fastening groove GVI of the inner circumferential surface of the female connector 700, thereby strongly coupling the female connector 700 with the male connector 1200.

When designing the diameters of the bodies 1230 and 1730 of the male connectors 1200 and 1700 of FIGS. 14 and 19 to be greater than those of the bodies 730 and 1130 of the female connectors 700 and 1100, the male connectors 1200 and 1700 may surround the female connectors 700 and 1100 while coupling therewith.

In this case, particularly, one of the fastening groove GVO and the fastening groove HMO formed on the outer circumferential surfaces of the bodies 730 and 1130 of the female connectors 700 and 1100 is coupled with the projecting part EBLI formed on the inner circumferential surface of the body 1730 of the male connector 1700, thereby strongly coupling the male connector 1770 with one of the female connectors 700 and 1100.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention may be applied to the field of manufacturing connectors.

1-19. (canceled)

20. A female connector comprising:
a core conductor formed in a single body comprising a contact terminal formed of two insertion panels forming an insertion space where a signal pin of a corresponding male connector is inserted, and a signal transmission panel connected to a bottom of the contact terminal and electrically connected to a signal line of a printed circuit board (PCB);
a body comprising an incision part electrically insulated from the core conductor and gaping when coupled with the male connector, the body formed of a single body comprising a trunk surrounding the contact terminal, and a plurality of supporters connected to a bottom of the trunk; and
a dielectric coupling the core conductor with the bottom of the trunk of the body,
wherein, on the trunk, a fastening groove is formed along an inner circumferential surface thereof.

21. The female connector of claim 20, wherein the fastening groove is coupled with the male connector to prevent separation of the male connector.

22. The female connector of claim 20, wherein a pair of gap-preventing panels formed to interpose the incision part therebetween and prevent the incision part from gaping is further formed on the bottom of the trunk.

23. The female connector of claim 22, wherein the signal transmission panel passes through the pair of gap-preventing panels and is connected to the signal line.

24. The female connector of claim 20, wherein the signal transmission panel is connected to the PCB using surface mount technology.

25. The female connector of claim 24, wherein the PCB is a flexible PCB.

26. The female connector of claim 20, wherein the core conductor, the bottom of the trunk, and the dielectric are coupled with one another using an insert molding method.

27. A female connector comprising:
a core conductor formed in a single body comprising a contact terminal formed of two insertion panels forming an insertion space where a signal pin of a corresponding male connector is inserted, and a signal transmission panel connected to a bottom of the contact terminal and electrically connected to a signal line of a PCB;
a body comprising an incision part electrically insulated from the core conductor and gaping when coupled with the male connector, the body formed of a single body comprising a trunk surrounding the contact terminal, and a plurality of supporters connected to a bottom of the trunk; and
a dielectric coupling the core conductor with the bottom of the trunk of the body,
wherein, on the trunk, one or more fastening grooves are formed along an inner circumferential surface thereof.

28. The female connector of claim 27, wherein the one or more fastening grooves are coupled with the male connector to prevent separation of the male connector.

29. The female connector of claim 27, wherein a pair of gap-preventing panels formed to interpose the incision part therebetween and prevent the incision part from gaping is further formed on the bottom of the trunk.

30. The female connector of claim 29, wherein the signal transmission panel passes through the pair of gap-preventing panels and is connected to the signal line.

31. The female connector of claim 27, wherein the signal transmission panel is connected to the PCB using surface mount technology.

32. The female connector of claim 31, wherein the PCB is a flexible PCB.

33. The female connector of claim 27, wherein the core conductor, the bottom of the trunk, and the dielectric are coupled with one another using an insert molding method.
